(19) United States
(12) Patent Application Publication
(10) Pub. No.: US 2005/0122444 A1
(43) Pub. Date: Jun. 9, 2005

(54) Reflector of backlight assembly for liquid crystal display device

(75) Inventors: Chien-Hung Kuo, Taichung (TW); Chuan-Pei Yu, Ilan (TW); Han-Chou Liu, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corporation

(21) Appl. No.: 10/727,616

(22) Filed: Dec. 5, 2003

(51) Int. Cl. G02F 1/1335

(52) U.S. Cl. 349/61

(57) ABSTRACT

A liquid crystal display device that comprises a light-emitting source emitting light, and a reflector further comprising a base and a plurality of sidewalls extending from the base, wherein each of the sidewalls further comprises a multi-angle surface, in conjunction with the base, reflecting the emitted light toward a diffusion plate diffusing the reflected light.

### DESCRIPTION OF THE INVENTION

1. Field of the Invention

This invention relates in general to a backlight assembly for a liquid crystal display (“LCD”) device and, more particularly, to a reflector of a backlight assembly for a LCD device.

2. Background of the Invention

LCD devices may include reflection-type, transmission-type and reflective transmission-type displays. In a reflection-type LCD device, an image is displayed by reflecting ambient light or sunlight incident on the LCD device. In a transmission-type LCD device, an image is displayed by the light emitted from a light source such as a lamp provided to the LCD device. In a reflective transmission-type LCD device, which is half reflection type and half transmission type, uses both an external light source such as ambient light or sunlight, and an internal light source such as a lamp. The transmission-type or reflective transmission-type LCD devices may generally include a backlight assembly for providing light to light a LCD panel.

FIG. 1 shows a cross-sectional view of a backlight assembly 10 of a conventional transmission-type or reflective transmission-type LCD device. Referring to FIG. 1, backlight assembly 10 includes a lamp 12, a reflector 14, and a diffusion plate 16. Light emitted from lamp 12 is incident on reflector 14, reflected by reflector 14, and then transmits through diffusion plate 16. It is desirable that the reflected light transmits in a direction normal to the surface of diffusion plate 16, resulting in a maximum flux of light provided. However, reflector 14 usually includes a base portion 18 and sidewall portions 20 extending from base portion 18 at an angle θ. In such a “single-angle” structure of reflector 14, light reflected from sidewall portions 20 may form with respect to the normal direction of diffusion plate 16 an angle α large enough to deteriorate the total flux of light provided by backlight assembly 10.

### SUMMARY OF THE INVENTION

Accordingly, the present invention is directed to a backlight assembly that obviates one or more of the problems due to limitations and disadvantages of the related art.

To achieve these and other advantages, and in accordance with the purpose of the invention as embodied and broadly described, there is provided a liquid crystal display device that comprises a light-emitting source emitting light, and a reflector further comprising a base and a plurality of sidewalls extending from the base, wherein each of the sidewalls further comprises a multi-angle surface, in conjunction with the base, reflecting the emitted light toward a diffusion plate diffusing the reflected light.

In one aspect, the multi-angle surface is an infinite-angle surface.

In another aspect, the light emitting source, the reflector and the diffusion plate form a backlight assembly for the liquid crystal display device.

Also in accordance with the present invention, there is provided a liquid crystal display device that comprises a light-emitting source emitting light, a multi-angle reflector for reflecting the emitted light, and a diffusion plate for diffusing the reflected light.

In one aspect, the reflector further comprises a base formed substantially parallel to the light emitting source, a plurality of sidewalls extending from the base, and each of the sidewalls further comprising a multi-angle surface, in conjunction with the base, reflecting the emitted light toward the diffusion plate.

In another aspect, the multi-angle surface further comprises an infinite-angle surface and curved surface.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawing, which is incorporated in and constitutes a part of this specification, illustrates several embodiments of the invention and together with the description, serves to explain the principles of the invention.

### BRIEF DESCRIPTION OF THE DRAWINGS

FIG. 1 is a cross-sectional view of a conventional backlight assembly;

FIG. 2 is a cross-sectional view of a liquid crystal display device in accordance with one embodiment of the present invention; and

FIGS. 3A and 3B are cross-sectional views of a backlight assembly in accordance with one embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

FIG. 2 is a cross-sectional view of a liquid crystal display (“LCD”) device 30 in accordance with one embodiment of the present invention. LCD device 30 is not necessarily drawn to scale, in which the dimensions of various components may be arbitrarily increased or reduced. Referring to FIG. 2, LCD device 30 includes a LCD panel 32 for displaying video images, and a backlight assembly 34 for lighting LCD panel 32. Backlight assembly 34 includes a lamp 36, a reflector 38, and a diffusion plate 40. Lamp 36 functions to serve as a light-emitting source. In one embodiment according to the invention, lamp 36 includes a cold-cathode fluorescent lamp attached within reflector 38. Reflector 38 reflects the light emitted from lamp 36 toward diffusion plate 40, which in turn diffuses the reflected light to LCD panel 32. In a further embodiment according to the invention, diffusion plate 40 is made of acrylic resin.

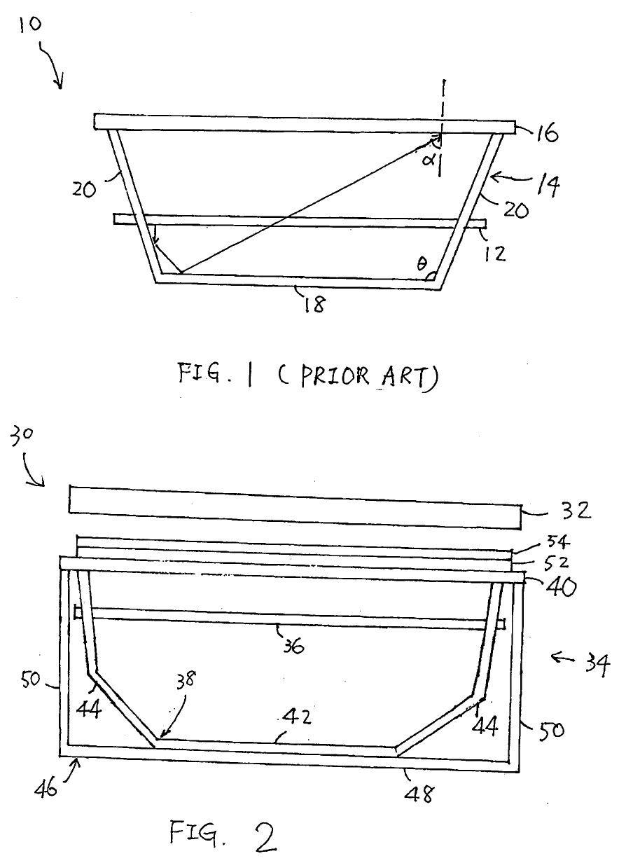

Reflector 38 includes a base portion 42 and sidewall portions 44 extending from base portion 42. Each sidewall portion 44 includes a multi-angle surface (not numbered) such that the light emitted from lamp 36 is reflected by the multi-angle surface and base portion 42 toward diffusion plate 40. The multi-angle surfaces help alleviate the problem of a large angle α in a single-angle structure as discussed with respect to FIG. 1.

Backlight assembly 34 generally includes a frame 46 for accommodating lamp 36 and reflector 38. Frame 46 includes a base portion 48 on which reflector 38 is mounted, and sidewall portions 50 extending from base portion 48 to support diffusion plate 40. Backlight assembly 34 may also include optical sheets (not numbered) formed on diffusion plate 40 in lighting LCD panel 32. The optical sheets may include a prism sheet 52 formed on diffusion plate 40, and a diffusion sheet 54 formed on prism sheet 50.

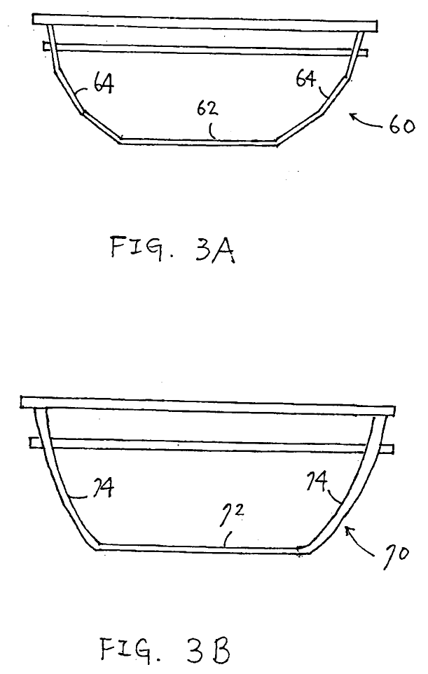

In the example of FIG. 2, reflector 38 includes a two-angle sidewall surface. In other embodiments, however, a reflector may include a sidewall surface having more than two angles, as shown in FIGS. 3A and 3B. Referring to FIG. 3A, a reflector 60 includes a base portion 62 and a three-angle sidewall surface 64. Referring to FIG. 3B, a reflector 70 includes a base portion 72 and an infinite-angle sidewall surface 72. That is, reflector 70 includes a curved sidewall surface.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A liquid crystal display device comprising:
a light-emitting source emitting light; and
a reflector further comprising a base and a plurality of sidewalls extending from the base,
wherein each of the sidewalls further comprises a multi-angle surface, in conjunction with the base, reflecting the emitted light toward a diffusion plate diffusing the reflected light.

2. The device of claim 1, the light emitting source further comprising a lamp.

3. The device of claim 1, the light emitting source further comprising a fluorescent lamp attached in the reflector.

4. The device of claim 1, the diffusion plate being made of acrylic resin.

5. The device of claim 1, the multi-angle surface being an infinite-angle surface.

6. The device of claim 1, the light emitting source, the reflector and the diffusion plate forming a backlight assembly for the liquid crystal display device.

7. The device of claim 1 further comprising a frame accommodating the light emitting source and the reflector.

8. The device of claim 7, the frame further comprising:
a base portion mounting the reflector; and
a plurality of sidewall portions extending from the base portion and supporting the diffusion plate.

9. The device of claim 1 further comprising a plurality of optical sheets formed on the diffusion plate.

10. The device of claim 1 further comprising:
a prism sheet formed on the diffusion plate; and
a diffusion sheet formed on the prism sheet.

11. A liquid crystal display device comprising:
a light-emitting source emitting light;
a multi-angle reflector for reflecting the emitted light; and
a diffusion plate for diffusing the reflected light.

12. The device of claim 11, the reflector further comprising:
a base formed substantially parallel to the light emitting source;
a plurality of sidewalls extending from the base; and
each of the sidewalls further comprising a multi-angle surface, in conjunction with the base, reflecting the emitted light toward the diffusion plate.

13. The device of claim 11, the light emitting source further comprising a lamp.

14. The device of claim 11, the light emitting source further comprising a cold cathode fluorescent lamp.

15. The device of claim 11, the diffusion plate being made of acrylic resin.

16. The device of claim 11, the multi-angle surface further comprising an infinite-angle surface and curved surface.

17. The device of claim 11 further comprising a frame accommodating the light emitting source and the reflector.

18. The device of claim 17, the frame further comprising:
a base portion mounting the reflector; and
a plurality of sidewall portions extending from the base portion and supporting the diffusion plate.

19. The device of claim 11 further comprising a plurality of optical sheets formed on the diffusion plate.

20. The device of claim 11 further comprising:
a prism sheet formed on the diffusion plate; and
a diffusion sheet formed on the prism sheet.
